(19) United States
(12) Patent Application Publication
(10) Pub. No.: US 2009/0116980 A1
(43) Pub. Date: May 7, 2009

(54) Air and water conditioner by two separated air flows

(76) Inventor: Julio A. Monjes, Tucson, AZ (US)

Correspondence Address: Julio A. Monjes, 1200 E. River Rd-L166, Tuscon, AZ, 85718, US

(21) Appl. No.: 11/900,778

(22) Filed: Sep. 14, 2007

(51) Int. Cl. F28D 5/00; F25D 21/14; F04B 35/04; B01F 3/04

(52) U.S. Cl. 417/410.1; 62/314; 62/291; 261/161

(57) ABSTRACT

This device is a water adiabatic evaporative cooler of two separated air flows contained in a cylindrical body, there is the humid peripheral flow which comprises the components of the water evaporation system, the other is the central flow designated as the ambient dry flow where the air current produces the cooling effect. The two air flows are generated by a single axial air blower, the central zone of the air blower drives the atmospheric air through a central concentric body containing an air to water heat exchanger, this is the air to be directed to the controlled ambient, while the peripheral part of the single axial blower drives the air through an external annular adiabatic evaporation chamber, from here the cool condensed moisture goes to the heat exchanger while residual humid air is evacuated to the external atmosphere.

### BACKGROUND OF THE INVENTION

This device is a water adiabatic evaporative cooler of two separated air flows embodied in a single unit contained into a cylindrical body, the system is also capable of working as an air heating there by controlling the temperature of an enclosed ambient within a wide range of values.

Evaporative coolers in present use achieve a temperature reduction of the circulating air by driving the air though a wet surface producing an evaporative process, this is an isenthalpic process where the air temperature is lowered by heat transfer to the evaporating water, consequently the air's moisture is increased up to the dew point. Such final state may not be comfortable when the initial air temperature and relative moisture are only a few degrees from dew point. This characteristic limits the application of this type of cooling to very dry weather conditions.

Various systems have been patented to solve such shortcomings: U.S. Pat. No. 5,050,391 refers to a double sided heat exchanger having a dry surface along which the air flows, the opposite side of such surface is cooled by water evaporation. These general methods of cooling one surface of one element by water evaporation while cooling the usable air with the dray opposite side of the same element or another element thermally connected are the bases for U.S. Pat. No. 4,002,040 and U.S. Pat. No. 5,453,223. U.S. Pat. No. 4,171,620; U.S. Pat. No. 4,786,301; U.S. Pat. No. 4,864,830; U.S. Pat. No. 4,982575 and U.S. Pat. No. 5,460,004 all make use of desiccants to reduce the relative humidity of the cooled air.

In the present invention no desiccants are required and the porous wet element and or double sided opposite surfaces elements or evaporation channels are substituted by an annular evaporation chamber plus a second stage comprised by an air to water heat exchanger and water circulation pumps, this combination produces a cooler dryer air which is desirable for comfort. On Argentine patent AR016120A1 “Acondicionador de Aire Por Evaporacion y Calefactor, of this same author, the water drained from the first stage, evaporation channels, is mixed with the water drained from the second stage, in a common single tray, and pumped by a single pump to both stages.

On U.S. Pat. No. 6,324,862 of this author, uses two air blowers one for each stage and as well as in the previous one the water evaporation takes place in open channels where the spray is produced by impacting a water jet on a hard surface and mixes in an open flow of air, in both cases it is required a high water pressure and, the open channels tends to spill some of the water spray.

The present patent improves in the previous one as well as on the patent application Ser. No. 10/957,904 of this same author by increasing the evaporative capacity while reducing the manufacturing cost and power consumption by using a single annular evaporation chamber instead of multiple evaporation tubes and driving only one axial air impeller and two low-pressure water pumps, the spilling is non-existent since the evaporation takes place in a closed chamber instead of an array of open channel or tubes.

### BRIEF SUMMARY OF THE INVENTION AND DRAWINGS

This system is a water adiabatic evaporative cooler of two separated air flows embodied in a single unit contained into a cylindrical body, it is able to work in two operational modes, in mode A works as an air cooler by adiabatic evaporation, in mode B the adiabatic evaporation is suppressed and the system works as a heating device.

In mode A as a cooler there is a peripheral air flow designated as humid air flow and comprises the components of the water evaporation system, the other is the central flow designated as the dry air flow and comprises the components of the atmospheric air cooling system. The two air flows are generated by a single axial air blower or impeller of several blades, the central part of the blades span drives the atmospheric air into and through a central concentric cylinder containing an air to water heat exchanger, while the peripheral part of blades span drives the air into and through an annular chamber, this is the evaporation chamber which surrounds the central cylinder, the air intake to the said chamber takes place though an annular opening configured as a two dimensional adiabatic air expansion ventury, this two dimensional annular ventury is provided with small water ejection nozzles, the air ventury configuration induces a high speed air flow along the longitudinal direction of the chamber, this air flow acts on the ejection nozzles of the water ejection system producing a very fine water spray, one part of the spray evaporates, the rest drains into the cool zone of an annular collection tray placed under de said evaporation chamber. The heat of vaporization extracted from the water greatly reduces the temperature in the droplets interior, the so cooled water collected in the cool zone of the water tray is pump circulated through the cooling stage in the central body, the cooling stage consist of an air to water heat exchanger and two water circulation pumps. The cool water circulating inside the tubes of the heat exchanger decreases the temperature of the air flowing around the external surface of the tubes while increasing the water temperature, this warm water output from the cooling exchanger is collected in the warm zone of the water tray and pump directed to the water ejection ports in the air ventury, while the cold water drained from the evaporation chamber is pump directed to the heat exchanger; thereby starting a new cycle, where the heat of the central air flow is extracted in the heat exchanger and evacuated to the atmosphere in the humid air produced in the evaporation chamber. Also the method of adiabatic expansion in the ventury produces a very fine spray even for large diameter water nozzles, thereby avoiding the clogging so frequent in a system with pressure spraying requiring small diameter ejection holes.

In mode B working as a heating device there is a heating element in the water collection tray, such that when this element it is activated the heat exchanger receives hot water, at the same time a valve stops the water output from the heat exchanger to the nozzles in the annular ventury, such that there is no evaporation in the peripheral flow, by such action the water and airflows are redirected back to the heat exchanger and the system becomes an air heater.

In both configurations A as a cooler or B as a heater, the cool and hot water zones of the collection tray can be connected in close loop, by suitable water lines to a remote heat exchanger operated by an independent electric motor. The main components of the invention are depicted in the following figures.

FIG. 1 is a longitudinal cross section showing the components of the system in the two configurations A as a cooler and B as a heater.

FIG. 1A is the cross section AA showing the horizontal ports for the return air when the system works as a heater.

FIGS. 1B and 1C both of them shows in each view the different airflow in the distribution chamber when the system works as a cooler and as a heater respectively.

FIG. 2, is the cross section BB of FIG. 1 and the plan view of the internal components below it, such as the annular evaporation chamber, the air impeller and the annular water collection tray.

FIG. 3, shows the front view, plus the transversal and longitudinal cross sections of the air to water heat exchanger.

FIG. 4, show the remote cooling stage.

FIG. 5, is a block diagram illustrating the air and water operational cycles.

### DETAILED DESCRIPTION OF THE INVENTION AND DRAWINGS

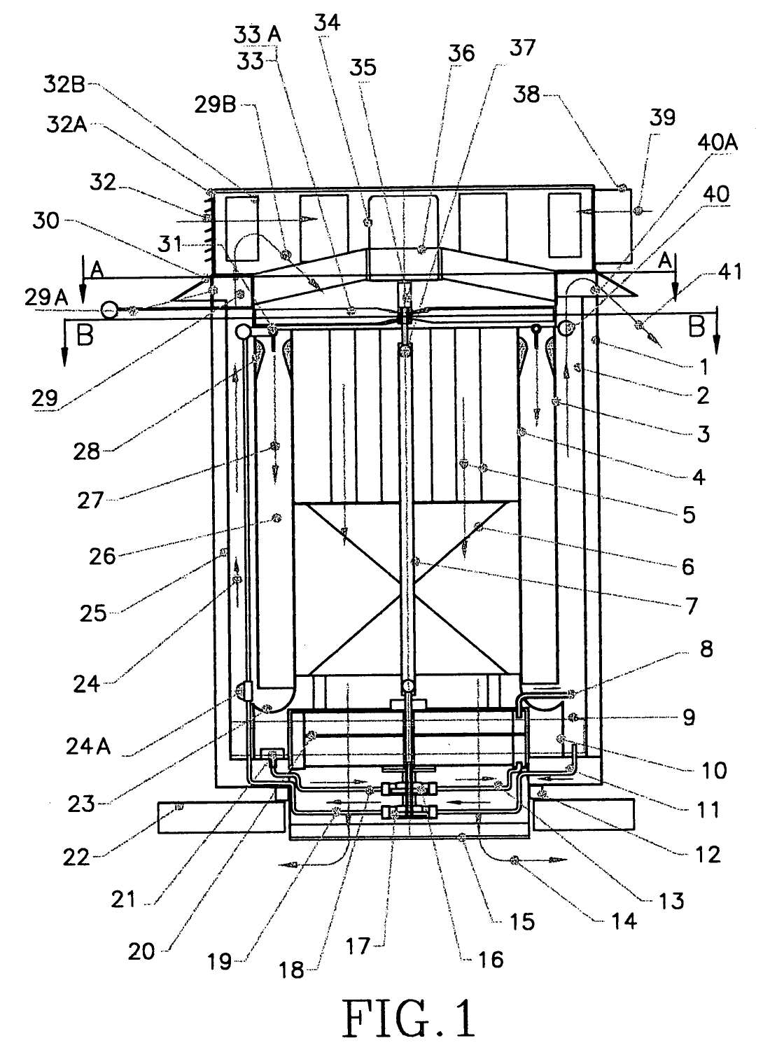

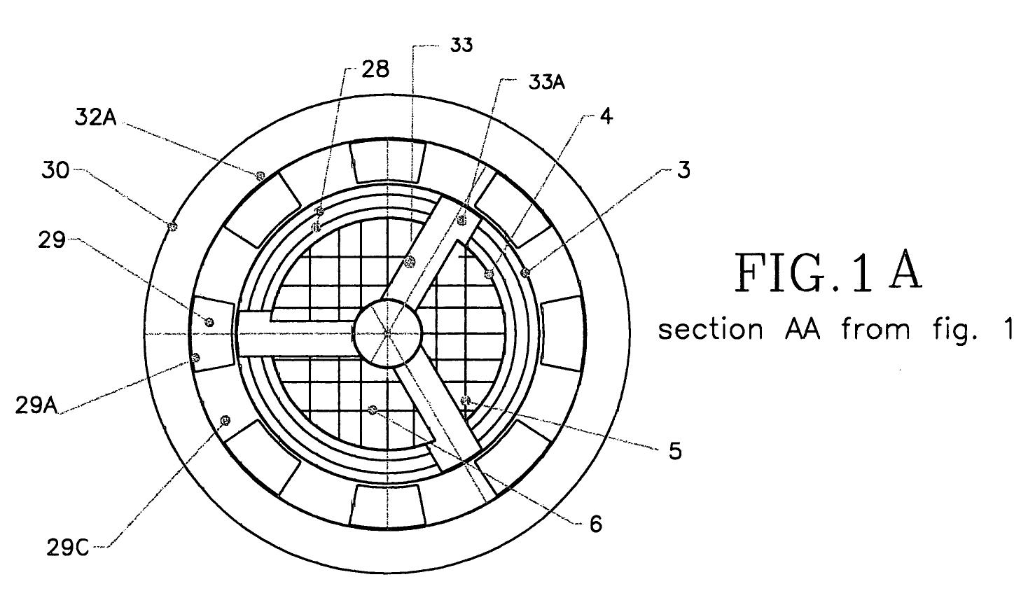

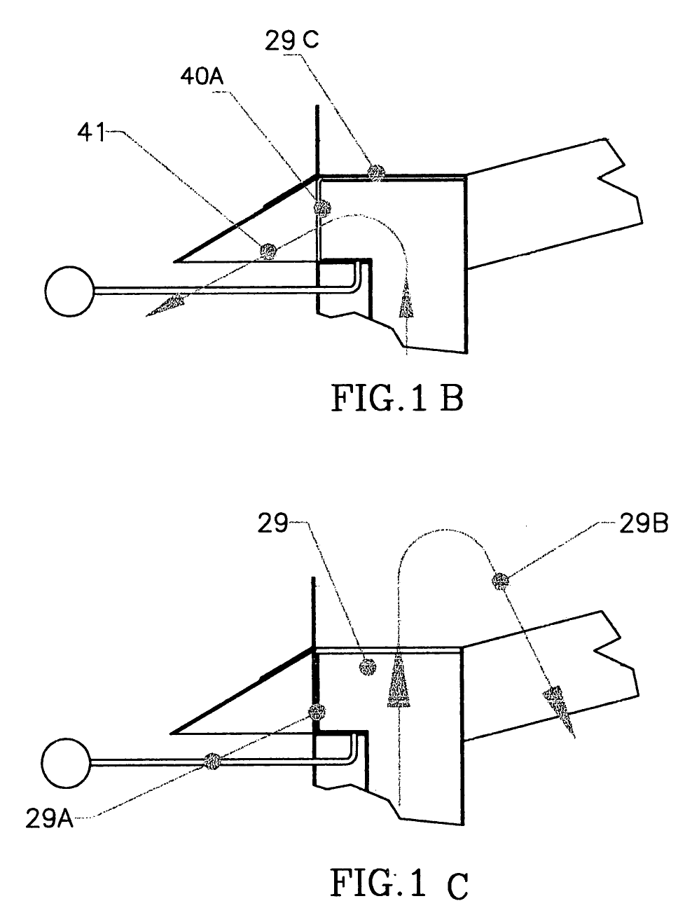

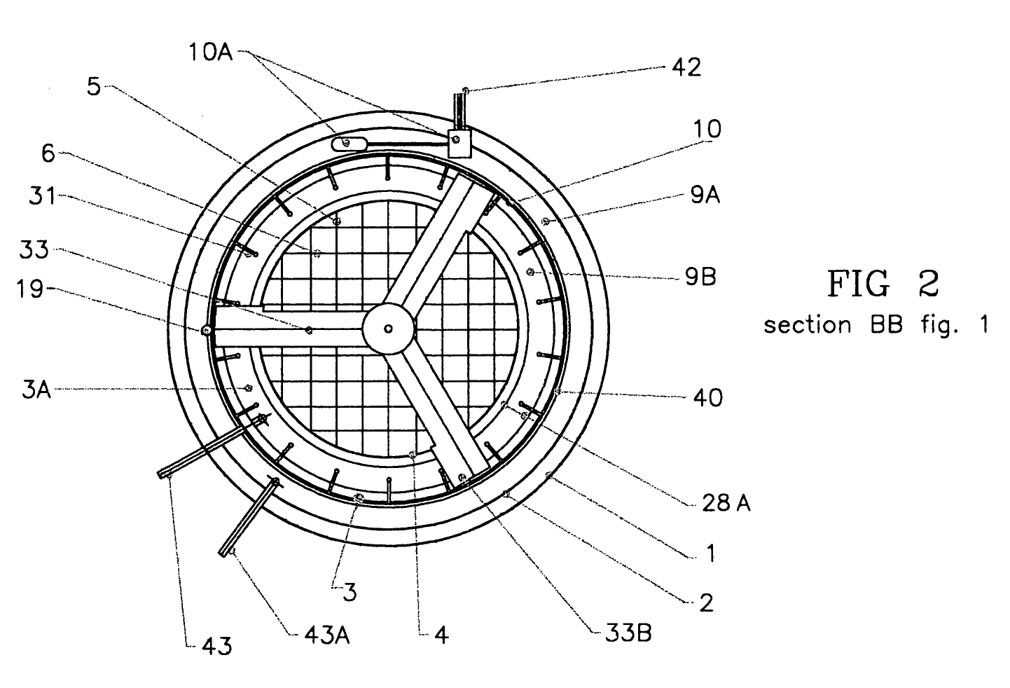

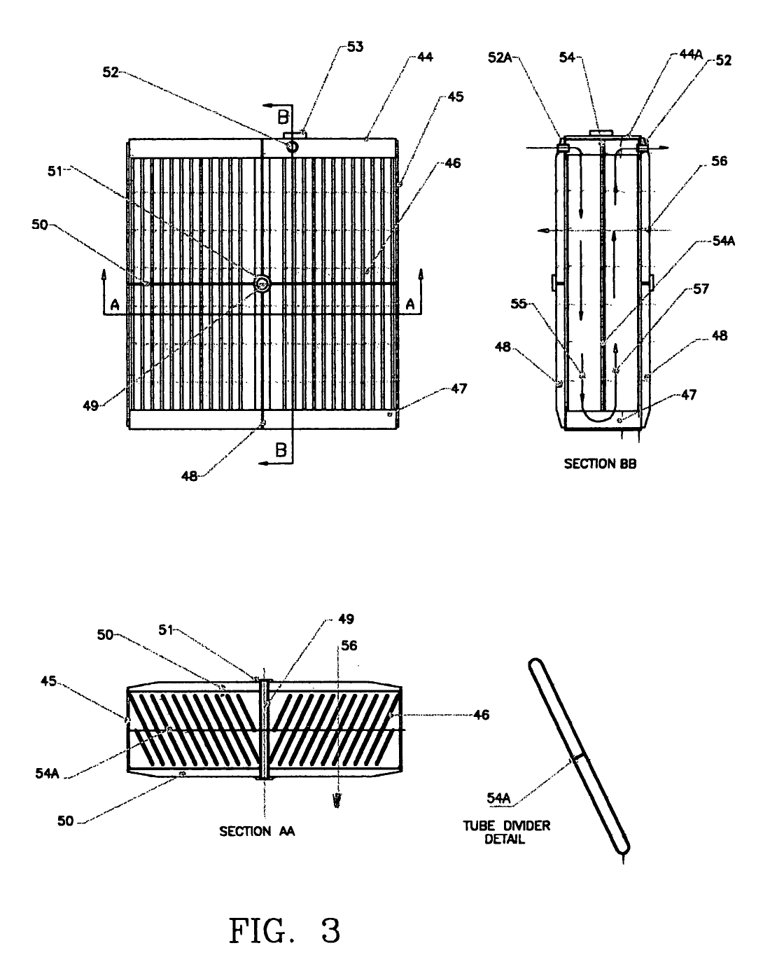

The detailed description and functioning of each part will follow the natural number sequence of FIGS. 1, 1A, 1B and 1C simultaneously. In FIGS. 2 and 3 the items are not in the natural numbers sequence, a number and a letter identify related parts not shown in FIG. 1.

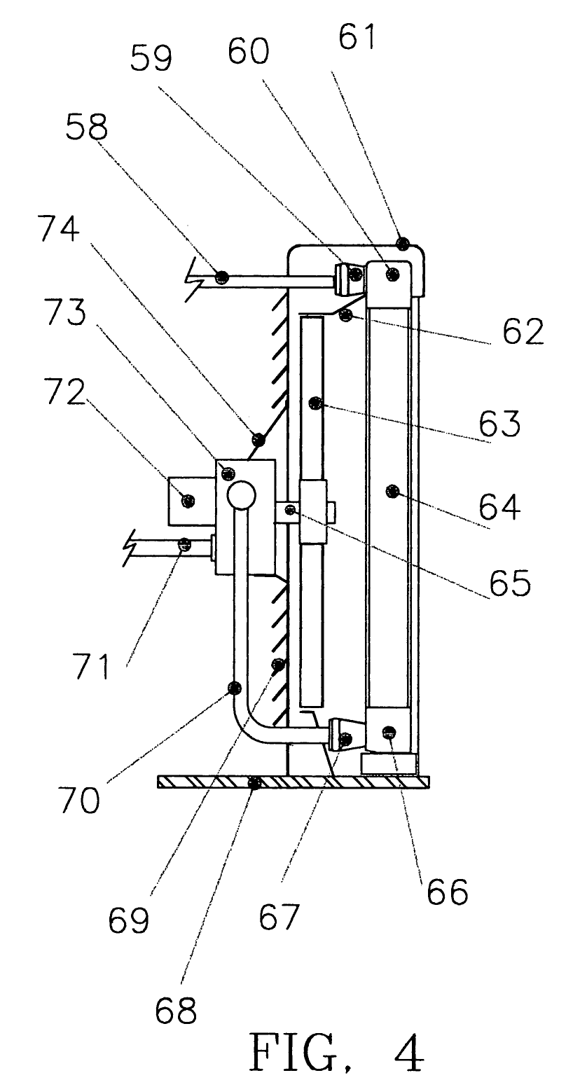

For all figures the description of the items is given in clockwise direction but only in FIG. 1 and 4 are in the natural sequence.

FIGS. 1, 1A, 1B, and 1C is a longitudinal cross section of FIG. 2, and it shows most of the components installed in an enclosure compatible with fixed commercial or domestic usage, the system can work as a cooler or as a heater in open or closed air loop by properly setting the air re-circulation openings in the air system.

In FIGS. 1, 1A, 1B, and 1C we have

Item 1, is the outer integral enclosure

Item 2, is the system's external cylinder thermally insulated by the #1 enclosure and the annular space between both of them.

Item 3, is the intermediate cylinder part of the annular evaporation chamber

Item 4, is the inner cylinder, part of the annular evaporation chamber conforming also the central enclosure of the system, the airflow from the central portion of the impeller enters this central enclosure, while the air flow from the marginal portion of the impeller enters the space conformed by the central cylinder and the intermediate cylinder making the evaporation chamber.

Item 5, shows the direction of the air stream through the central core and the streamlining parallel vertical panels extending from the admission end of the inner cylinder up to half the total length.

Item 6, is the second set of parallel streamlining vertical panels like that of #5 but rotated 90 degrees and located in the lower half part of the inner cylinder.

These two in series set of perpendicular panels serves to streamline the air flow decreasing the turbulence and increasing the back pressure in the central air impeller output, achieving noise reduction.

Item 7, is the extension of the output shaft of the electric motor, which drives the air impeller. The said extension is connected to the shaft of the two in line water pumps located on the system lower end or air output exit, at both ends the power connection is by universal joints.

Item 8, is the warm water output tube from the heat exchanger.

Item 9, indicates the constant operational water level in the tray.

Item 10, is the divider-perforated wall between the warm water tray and the cool water tray zones.

Item 11, is the water line from the warm zone of the water tray to the warm water pump #1 7, arrows indicates always water flow directions.

Item 12, is the structural mounting ring to the building supporting the unit.

Item 13, is the cold water line from pump 1 6 to the heat exchanger's input.

Item 14, indicates the air direction to the distribution system.

Item 15, is the air filter.

Item 16, in the A configuration this is the cool water pump from the tray to the heat exchanger; in the B configuration this becomes the hot water pump.

Item 17, is the warm water pump from the tray to the nozzles in the ventury.

Item 18, is the cold water line from the tray to the pump.

Item 19, is the warm water input line to the water nozzles.

Item 20, is the body of the heat exchanger.

Item 21, is the water connector and the heating element to the line and pump toward the heat exchanger water input, when working as a cooler the heating element is off.

Item 22, is the structure of the building.

Item 23, is the moist cool air water separator in the A configuration, this separator has perforations for discharging the cool water produced in the evaporation chamber to the cool water zone of the water collection tray.

Item 24A, when working as a heater this is the valve that stops the flow of warm water to the nozzles in the ventury discharging to the hot water tray.

Item 24, indicates the direction of the moist airflow in the outer annular space toward the atmosphere in the A configuration.

Item 25, is the thermal insulation space between the annular evaporation chamber and the external ambient.

Item 26, is the annular evaporation chamber longitudinal cross section.

Item 27, indicates the direction of the air driven by the peripheral zone of the axial air impeller #33.

Item 28, shows the cross section of the adiabatic air ventury.

Item 29, in FIGS. 1, 1A and 1C points the annular air distribution chamber for the system to change from A to B configuration, in FIG. 1 A points to the horizontal air transfer port from the distribution to the admission chamber.

Item 29A, points to the shutter and control arm that in the B configuration will shutoff the air to the outside ambient, and in the A configuration will open it for exhaustion of moist air to the atmosphere.

Item 29B in FIGS. 1 and 1C shows the internal air direction in B configuration. Item 29C in FIGS. 1A-1B shows the air shut off condition in A configuration.

Item 30, is the truncated cone moist air deflector to the atmosphere.

Item 31, is one of the water nozzles inside the air ventury.

Item 32, indicates the direction of the external air through the openings of the top cover comprising the air admission chamber.

Item 32A, are the air admission louvers located around several separated zones on the cylindrical perimeter of the top cover.

Item 32B, are the openings in the regulation cylinder for control of external air intake, this is an internal cylinder concentric with the external cover perimeter of 32A, by rotating the regulation cylinder respect to the external cover the intake open area ratio between the external and internal air intake is controlled. Item 33, this is the full span of the axial air impeller.

Item 33A, is the marginal span part of the air impeller seen in FIG. 1A

Item 34, is the electric motor that drives the air impeller and the two water pumps.

Item 35, is the coupling between the electric motor shaft and the impeller's shaft as well as the connecting shaft to extension shaft #7.

Item 36, is the electric motor mounting bracket.

Item 37, is the universal joint at both ends of the extension shaft #7.

Item 38, is the adaptor for closed air loop operation.

Item 39, indicates the direction of the air for closed loop operation with the internal ambient.

Item 40, is the all around water distribution manifold.

Item 40A, shows the exhaust port in the open position for the moist air in A configuration, also show in FIG. 1B.

Item 41, indicates the moist air exhaust direction to the outside atmosphere, also show in FIG. 1B

In FIG. 2 we have

This figure is the plan view of the unit with the components above the plane of the axial impeller removed, it shows in a plan view the annular configuration for the evaporation chamber and the annular throat of the air intake ventury. Parts numbers are listed clock wise starting from the top, details of parts related to FIG. 1 are indicates with the same number followed by a letter.

Item 10A, is the water level floating control system.

Item 42, is the external water supply line.

Item 10, is the divider-perforated wall between the warm and cool water zones of the annular water tray.

Item 9A, is the warm water zone of the annular tray.

Item 9B, is the evaporation chamber that discharges in the cool water zone of the annular tray.

Item 40, is the all around warm water distribution ring manifold.

Item 28A, is the annular ventury's throat of the evaporation chamber. Item 1 is the integral enclosure conforming an insulated annular space with the system external cylinder #2.

Item 2, is the system's external cylinder thermally insulated by the #1 integral enclosure and the annular space between both of them.

Item 33B, is the marginal zone of one of the blades of the axial impeller, this zones blows the air into the annular vaporization chamber.

Item 4, is the central enclosure containing the air streamliner panels #5 and #6. Item 3, is the intermediate cylinder.

Item 43A, is the warm water return connector from the optional remote heat exchanger.

Item 43, is the cool water connector to the optional remote heat exchanger.

Item 3A, is the plan view of the annular evaporation chamber.

Item 19, is the warm water feeding lines from the warm water pump to the ring manifold #40.

Item 33, is one the blades of the central zone of the axial air impeller, this zone blows the air through the streamliners in the central core to the heat exchanger and toward the internal ambient.

Item 31, is one of the pluralities of water nozzles in the center of the air ventury throat.

Item 5, is one of the air streamliner panels of one part of the central core.

Item 6, shows the streamliner panels at 90 degrees to the panels of item # 5.

In FIG. 3 we have:

This is the air to water heat exchanger; it shows the frontal view and two perpendicular cross sections.

In the frontal view we have:

Item 44, is the divided input-output header.

Item 45, is the lateral structure that holds the divided header #44 to the connecting header #47.

Item 46, is one of the multiplicity heat transfer tubes.

Item 47, is the connecting header.

Item 48, is one of the longitudinal arms holding the central hub flange #51.

Item 49, is the central hub centering tube.

Item 50, is one of the traversal arms holding the central hub flange #51.

Item 51, is one of the two the central hub flanges.

Item 52, is the water output connector.

Item 53, is the filling cup cover.

In the Cross Section BB we have:

Item 52A, is the water input connector.

Item 54, is the internal wall that divides by two half the divided header #44.

Item 44A, is the output half of the divided input- output header.

Item 52, is the water output connector.

Item 56, indicates the air flow direction.

Item 54A, is the tubes longitudinal divider coincident with #54.

Item 57, indicates the water flow direction in the second row of tubes.

Item 47 is the connecting header.

Item 48, is one of the longitudinal arms holding the central hub flange.

Item 55, is the water flow direction in the first row of heat transfer tubes.

Item 52A, is the water input connector.

In the Cross Section AA we have:

This figure shows the heat transfer tubes cross section, which are of an elongated cross section and at a disposition with a pronounced slanted angle respect to the airflow direction, in such manner that the air flow keeps bouncing from one side to the other side in the inter space between contiguous tubes. This configuration takes advantage of the Reynolds' principle indicating that the heat transfer coefficient between two fluids separated by a wall is proportional to the momentum change of the fluids flowing on each side of the separating wall. In this design the momentum change is consequence of the directional changes of the airflow trough the tubes of the heat exchanger, making unnecessary the use of the expensive external heat conduction fins.

Item 50, is one of the central hub's transversal holding arm.

Item 51, is the central flange.

Item 49, is the central hub centering tube.

Item 56, indicates the airflow direction.

Item 46, is one of the heat transfer tubes.

Item 54A, is a enlarged cross section showing the longitudinal divider in the multiplicity of tubes #46.

Item 54A, is the tubes longitudinal divider coincident with #54.

Item 45, is the lateral structure that holds the #44 and #47 as a single unit.

FIG. 4 Shows the Remote Cooler Configuration where we have:

Item 58, is the warm water output return line to the main unit.

Item 59, is the connector to the return line #58.

Item 60, is the water output header of the heat exchanger.

Item 61, is the external cover of the unit.

Item 62, is the shroud of the air impeller #63.

Item 63, is the air impeller.

Item 64, is the body of the heat exchanger.

Item 65, is the motor shaft of the impeller.

Item 66, is the cold water input header.

Item 67, is the cold water input connector.

Item 68, is the mounting base of the remote cooler.

Item 69, are the protection air louvers.

Item 70, is the cool water line from the pump.

Item 71, is the cool water line from the main unit.

Item 72, is the electric motor.

Item 73, is the water pump.

Item 74, is the motor-pump holding bracket.

### FUNCTIONING OF THE INVENTION

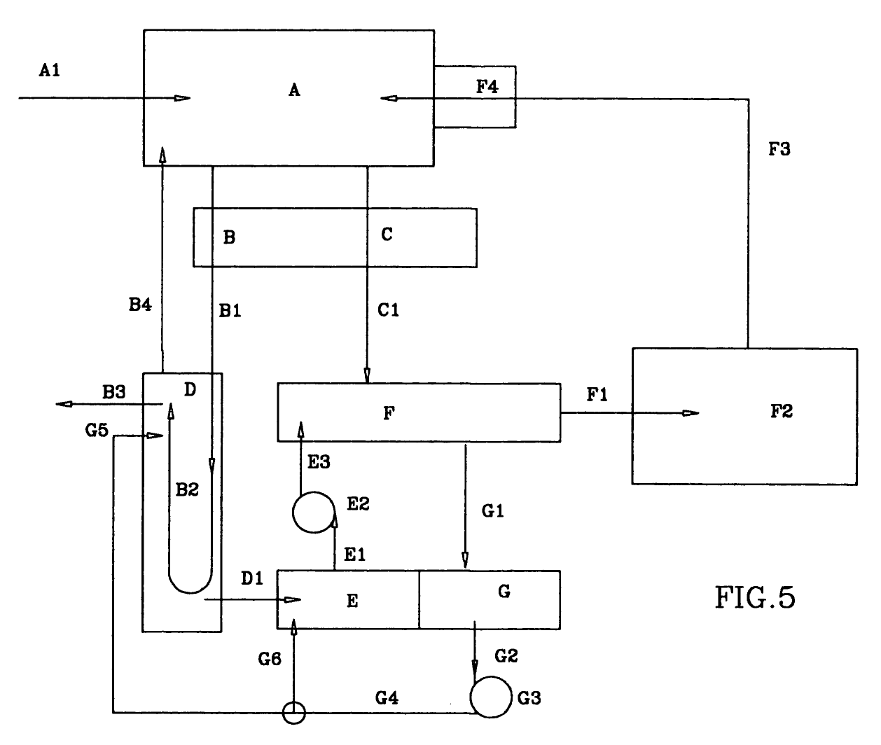

The functioning of the overall system working as a cooler in configuration A and as a heater in configuration B is explained with the help of the block diagram of FIG. 5, where each sub-system is designated by a capital letter and a number. Following the component parts of FIGS. 1, 1A, 1B, 1C, 2 and 3 we have:

A, A1: air induction system, comprised by items 32, 32A, 32B, 38 and 39.

B, B1, B2, B3: peripheral air circulation system comprised by items: 29, 29A, 33, 33B 34, 35, 36 and 41.

C, C1: central or dry air circulation system, comprised by items: 5, 6, 33, 34,35 and 36.

D, D1, D2: water evaporation system, comprised by items: 1, 2, 3, 4, 23, 24, 24A, 25, 26, 27, 28, 29, 30, 31, 33A and 41.

E, E1, E2, E3: cool water circulation system, comprised by items: 9, 10, 13, 16, 18, 20 and 21.

F, F1, F2, F3, F4: air to water heat exchanger system and internal ambient with air closed loop system, comprised by items: 14, 15, 20, 38 and 39.

G, G1, G2, G3, and G4: warm water circulation system comprised by items 8, 11, 17, 19, 24A and 31.

The sequential steps leading to the generation of two airflows of different temperature and moisture starting with a single thermodynamic state for configuration A as cooler is:

A1 is the external air flow into the air admission chamber A, from here the peripheral zone of the axial impeller B produces the high velocity air flow B1 to the evaporation chamber D, here the moisture of the air stream is increased beyond the saturation limit by ejection of water through water nozzles, the evaporation and cooling of the water starts at the throat of the ventury placed at the admission port of D, the cooled water at D discharges through D1 into the cold zone E of the water tray, while the moist air at B2 is evacuated to the atmosphere at B3. From the central zone C of the impeller the atmospheric air is directed by C1 toward the heat exchanger F; here the atmospheric air is cool down by the thermal conductivity of the tubes comprising the heat exchanger, following the direction F1 the air goes to the internal ambient F2, this internal ambient air can be circulated back as F3 to the air admission chamber through the closed loop adapter F4 mixing in A with external air and in this way completing air cycle.

The water cycle starts at the cool water collection tray E, then we have E2 is the cool water pump that trough E1 and E3 directs the cold water from E to the heat exchanger F, here the cool water absorbs the heat from the air C1 and the water temperature increases discharging by G1 into the warm zone G of the water collection tray, the warm water pump G3 directs the water through G2 and G4 to the nozzles G5 in the evaporation chamber D, here the water is cooled by adiabatic evaporation draining into the cool zone E, the evaporated fraction of the water goes to the atmosphere as moist air at B3, the water fraction that is not evaporated achieves a lower temperature by yielding heat during the adiabatic expansion in the ventury and evaporation chamber finally draining at D1 to the collection tray and in this way closing the water cycle.

The system produces two air flows using only one axial impeller, one air flow is the dry cool air F1 directed to the internal ambient F2, the second is a moisture oversaturated air flow that discharges to the external atmosphere B3. The vaporization heat of water is more than five hundred times greater than the calefaction heat of water, such that by evaporating only a fraction of 1/100 of the warm circulating water mass, it is possible to cool down by several degrees a mass two orders of magnitude greater than the evaporated mass.

For configuration B as a heater, the air and water circulation systems are changed as follows: the peripheral air flow B, B1, B2 is diverted in the direction B4 toward the admission chamber A and from here to the central air C1, from where it follows the circuit all the way to the heat exchanger and the internal ambient F2. For the water circuit the flow G4 does not reach the water ejection nozzles in the ventury of the evaporation chamber instead it is diverted by the valve G6 to the warm zone of the collection tray and to the heat exchanger F, the water output E1 in the water tray incorporates a water heating element which is activated only in B configuration, in this way the water circulates only between the collection tray and the heat exchanger.

Having described the physical components and functioning of a thermo-mechanical embodiment denominated AIR AND WATER CONDITIONER BY TWO SEPARATED AIR FLOWS capable of controlling the temperature and moisture in an enclosed space. Variations in the previously described embodiment and configurations can be implemented without departing from the scope of the invention which is intended to be limited only by the scope of these Claims. What is claim of exclusive property are the following claims.

1. An air and water conditioner of two concentric air flows characterized by being of circular configuration where the unit is contained in a cylindrical envelope named as integral envelope, within which there are three concentric cylinders which are part of an annular evaporation chamber, the said three cylinders, central, intermediate and external cylinder define two air flows from a single axial air impeller, above the cylinders there is the said axial air impeller connected to the output shaft of an electric motor, at the lower end of the central and intermediate cylinder there is an air to water heat exchanger, on the air output side of the said impeller there are the central cylinder zone and the annular zone, the central span part of the impeller drives that central air flow into the central cylinder, the marginal span part of the impeller drives the air flow into the said annular zone which conforms the evaporation chamber, and circumscribes that fraction of the incoming air flow, this evaporation chamber is comprised by the said three concentric cylinders of different diameter, the smaller is the central cylinder, the second one is the intermediate cylinder, the third one is the largest named the external cylinder and conforming a perimeter closed space open at both ends, one end is the evaporation chamber's air admission port, which is shaped as an annular ventury conformed between the central and the intermediate cylinder, where this air admission port has a plurality of water ejection nozzles, and at the other end of the intermediate cylinder there is an annular air deflector whose cross section is shaped as a open channel with a multiplicity of perforations, under the said deflector there is the cool zone of an annular water collection tray, the shaped deflector reverses the air flow direction into the annular space between the intermediate cylinder and the external cylinder, this external cylinder is shorter than the intermediate cylinder as well as the integral envelope, leaving at the top end a circular aperture up to the integral envelope, which at this top end has a uniform distribution of exit ports to the atmosphere, this top space is designated as distribution chamber which is external to the evaporation chamber, this distribution chamber is conformed between the intermediate cylinder, the integral envelope and a horizontal disk that connects both cylinders, the integral envelope and the horizontal disk meets in the top edge with a moist air deflector shaped as a truncated cone that deflects the moist air downwards, the blades of the axial impeller extend from the center of the central cylinder up to the diameter of the intermediate cylinder, the internal cylinder in the top end is limited by the space for the said impeller and at the lower end is limited by the space of the heat exchanger, the heat exchanger is inside a prismatic box, in the lower end the central cylinder joints the heat exchanger box through adaptors in the four corners, after the heat exchanger there is the conduit to the internal ambient.

2. An air cooler as claimed on claim 1 where the air impeller flow is through the air admission chamber located above the distribution chamber on the low pressure side of the air impeller, the lateral area of the admission chamber is attached to the conical moist air deflector, the said area has several entrance ports at regular intervals around the external perimeter, the distance between the ports is equal to the aperture of the ports, one of the entrance ports has an adaptor for connection with air returning from the internal ambient, the said admission chamber has a top cover and the external lateral area extends from the top cover to the top of the integral envelope up to the conjunction with the distribution chamber and the conical moist air deflector, within the admission chamber there is an independent inside ring close to the internal perimeter of said chamber, this ring is free to rotate and has a disposition of entrance ports like the ones on the external perimeter of the admission chamber, after the said air impeller the electric motor drives through an extension with universal joints two in series water pumps located below the operational level of the water collection tray and under the body of the heat exchanger, the electric motor extension reaches the water pumps through a central cylindrical spacer integral with the body of the heat exchanger, one pump connects through proper lines the cool zone of the said collection tray with the input connector to the said heat exchanger, the other pump connects through proper lines the warm zone of the said collection tray to the said water nozzles in the air admission ventury end of the said evaporation chamber, after the heat exchanger there is the air conduit extension with an air filter and the conduct to the internal ambient.

3. An air cooler as claimed on claim 1 where the electric motor is mounted in the space inside the air admission chamber by an adaptor with several radial arms that are attached to the top part of the intermediate cylinder, the said motor drives the axial air impeller with several blades of a total span limited by the inside diameter of the intermediate cylinder, the blade's chords has an incremental discontinuity between the radius of the central cylinder and the radius of the limiter intermediate cylinder.

4. An air cooler as claimed on claim 1 where inside the central cylinder there is an air streamliner device comprised by two sets of spaced parallel panels were each set of panels are perpendicular to the other, where one of the two sets is on top of the other.

5. An air cooler as claimed on claim 1 which has a connector for an external water supply line, where the said supply line has a valve controlled by a lever and a float inside de annular water tray, said annular water tray also has two more connectors one from the cool zone and other to the warm zone both of which communicates in close loop mode with an optional remote cooling unit.

6. An air cooler as claimed on claim 1 which has an air to water heat exchanger comprised by heat conduction tubes without external heat conduction fins, the said tubes have standard smooth internal and external surfaces being of an elongated hollow cross section, each tube has a longitudinal divider from end to end conforming two similar longitudinal spaces in each tube, in the larger dimension of each tube the total cross section is oriented at a slanted angle respect to the air flow direction, such that in a transverse view the said water tubes conforms an array of parallel tubes facing at a slanted angle the incoming air current, the tubes can be arranged in one, two or more groups, being these groups symmetric about a central axis that is parallel to the incoming air flow direction, wherein the tubes of each group are parallel among themselves but are pointing at a symmetric angle respect to the tubes comprising the group across the axes of symmetry, the said tubes are connected by two transversal water headers, one at each end, one of the headers is divided by a wall in two half spaces, this is call the divider header, the divider wall is in coincidence and in the same plane that the end of the longitudinal divider of the tubes so it continues the separation of the two half of each tube , this divider header have two water connectors one in each longitudinal half, one for the cool water input and the other for the warm water output line; the other header does not have a divider and interconnects the two half of each tube, as well as the tubes among themselves and between symmetric groups, one of the headers has a water filler opening with a cap.

7. An air cooler as claimed on claim 1 which can be changed from cooling to heating unit by adding a heating element in the cool zone of the water collection tray plus a bypass valve in the warm water line between the warm water pump and the nozzles in the ventury of the evaporation chamber, the bypass valve output diverts the flow back to the warm zone of the water collection tray, while in the air circulation system there are added horizontal exit ports to the horizontal ring, this ports have a distribution equivalent to the vertical ports of the integral envelope but are shifted respect to the said vertical ports by an angular distance equal to the opening of a vertical port, plus the addition inside the distribution chamber of a free to rotate air distribution ring whose cross section has the shape of an inverted L with the vertical plane is parallel and close to the inside diameter of the integral envelope and the horizontal plane is parallel and close to the inside surface of the horizontal ring, this distribution ring has the same disposition of exit ports that the integral envelope and the horizontal ring, also there is a external lever attached to the said distribution ring.

8. An air cooler as claimed on claim 1 which has a remote cooling unit comprised by an air to water heat exchanger connected in closed loop configuration by two water lines to the main unit, one to the cool zone and the other to the warm zone of the collection tray, an independent electric motor is connected to an air impeller and a water pump, where all the said components are mounted inside a rigid protection cover on a stable base plate.
